(19) United States
(12) Patent Application Publication
(10) Pub. No.: US 2022/0322352 A1
(43) Pub. Date: Oct. 6, 2022

(54) COMMUNICATION APPARATUS, COMMUNICATION METHOD, AND STORAGE MEDIUM

(71) Applicant: CANON KABUSHIKI KAISHA, Tokyo (JP)

(72) Inventor: Mitsuyoshi Yukawa, Kanagawa (JP)

(21) Appl. No.: 17/724,983

(22) Filed: Apr. 20, 2022

Related U.S. Application Data
(63) Continuation of application No. PCT/JP2020/039754, filed on Oct. 22, 2020.

(30) Foreign Application Priority Data
Nov. 1, 2019 (JP) 2019-200320

(51) Int. Cl. H04W 72/04

(52) U.S. Cl. CPC H04W 72/0453; H04W 84/12

(57) ABSTRACT

A communication apparatus generates a management frame complying with an Institute of Electrical and Electronics Engineers (IEEE) 802.11 standard and transmits the generated management frame. The management frame includes a Multi-band element, and any of a set of 2.4 GHz band and 5 GHz band, a set of 5 GHz band and 6 GHz band, a set of 2.4 GHz band and 6 GHz band, and a set of 2.4 GHz band, 5 GHz band, and 6 GHz band is set as information indicating frequency bands to be used by the communication apparatus, to a Band ID value included in the Multi-band element.

### CROSS-REFERENCE TO RELATED APPLICATIONS

This application is a Continuation of International Patent Application No. PCT/JP2020/039754, filed Oct. 22, 2020, which claims the benefit of Japanese Patent Application No. 2019-200320, filed Nov. 1, 2019, both of which are hereby incorporated by reference herein in their entirety.

### BACKGROUND OF THE INVENTION

### Field of the Invention

The present invention relates to a communication apparatus performing wireless communication, and a wireless method.

### Background Art

Along with increase in communication data amount in recent years, development of a communication technique such as a wireless local area network (LAN) is progressing. As a main communication standard for the wireless LAN, Institute of Electrical and Electronics Engineers (IEEE) 802.11 standard series is known. The IEEE 802.11 standard series includes IEEE80.111a/b/g/n/ac/ax standards and the like. For example, in IEEE802.11ax, which is the latest standard, a technique using an orthogonal frequency-division multiple access (OFDMA) to improve a communication speed under a congested condition, in addition to high peak throughput of up to 9.6 gigabits per second (Gbps), is standardized (see PTL 1).

As a succeeding standard to further improve throughput, frequency utilization efficiency, and communication latency, a task group that is called IEEE802.11be was established.

In IEEE802.11be, it is examined that a frequency band of 6 GHz band is made usable in addition to frequency bands such as a 2.4 GHz band and a 5 GHz band which are usable for the wireless LAN so far. A technique that uses these frequency bands at the same time to enable wireless communication between an access point (hereinafter, AP) and a single station (hereinafter, STA) has been examined.

In the existing technique, the STA in the IEEE802.11 is connected to the AP, and performs data communication with the AP by using a single frequency band. In contrast, when the STA is connected to the AP and performs data communication at the same time with two or more wireless channels, it is possible to improve throughput. When a method in which a channel with less congestion out of the two or more wireless channels is used for data communication is adopted, improvement of latency is expected.

As described above, in IEEE802.11be, the simultaneous communication in the frequency bands of 2.4 GHz, 5 GHZ, and 6 GHZ is examined; however, in the existing technique, a method of notifying that the AP supports communication using the plurality of frequency bands is not present.

### CITATION LIST

### Patent Literature

PTL 1: Japanese Patent Laid-Open No. 2018-50133

### SUMMARY OF THE INVENTION

The present invention is directed to enabling notification that an apparatus supports wireless LAN communication using a plurality of frequency bands.

According to an aspect of the present invention, a communication apparatus includes a generation unit configured to generate a management frame complying with an Institute of Electrical and Electronics Engineers (IEEE) 802.11 standard, and a transmission unit configured to transmit the management frame generated by the generation unit. The management frame includes a Multi-band element, and any of a set of 2.4 GHz band and 5 GHz band, a set of 5 GHz band and 6 GHz band, a set of 2.4 GHz band and 6 GHz band, and a set of 2.4 GHz band, 5 GHz band, and 6 GHz band is set as information indicating frequency bands to be used by the communication apparatus, to a Band ID value included in the Multi-band element.

Further features of the present invention will become apparent from the following description of exemplary embodiments with reference to the attached drawings.

### BRIEF DESCRIPTION OF THE DRAWINGS

FIG. 1 is a diagram illustrating a network configuration example.

FIG. 2 is a diagram illustrating a functional configuration example of an access point (AP) or a station (STA).

FIG. 3 is a diagram illustrating a hardware configuration example of the AP or the STA.

FIG. 4 is a flowchart of processing which is performed by an AP according to a first exemplary embodiment.

FIG. 5 is a sequence chart of communication between the AP and an STA according to the first exemplary embodiment.

FIG. 6 is a diagram illustrating an example of a Multi-band element format.

FIG. 7 is a diagram illustrating an example of a Band ID field.

FIG. 8 is a flowchart of processing which is performed by an AP according to a second exemplary embodiment.

FIG. 9 is a sequence chart of communication between the AP and an STA according to the second exemplary embodiment.

FIG. 10 is a diagram illustrating an example of Band ID field according to a third exemplary embodiment.

FIG. 11A is a diagram illustrating an example of a Multi-band element format according to the third exemplary embodiment.

FIG. 11B is a diagram illustrating an example of a Multi-band element format according to the third exemplary embodiment.

### DESCRIPTION OF THE EMBODIMENTS

Some exemplary embodiments of the present invention will be described in detail below with reference to accompanying drawings.

### (Configuration of Wireless Communication System)

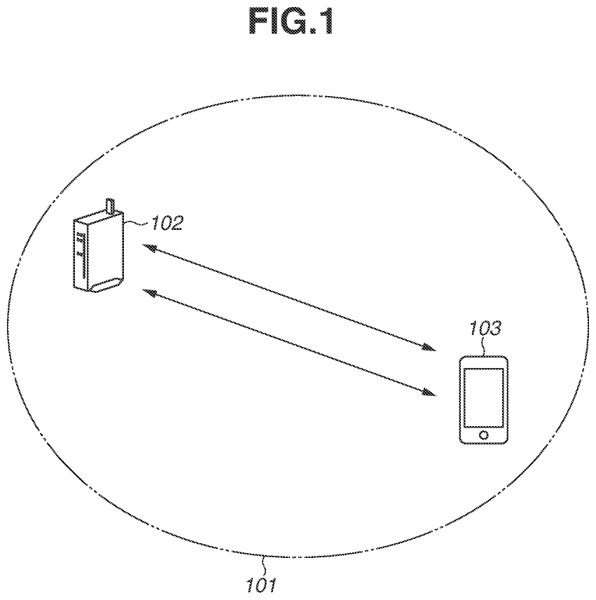

FIG. 1 illustrates a configuration example of a network according to an exemplary embodiment. FIG. 1 illustrates a configuration including one access point (AP) 102 and one station (STA) 103 as communication apparatuses that perform wireless local area network (LAN) communication complying with Institute of Electrical and Electronics Engineers (IEEE) 802.11be standard. As illustrated in FIG. 1, a network formed by the AP 102 is illustrated by a circle 101. The STA 103 can transmit and receive a signal received and transmitted by the AP 102.

In the present exemplary embodiment, each of the AP 102 and the STA 103 includes a plurality of wireless LAN control units, and can transmit and receive frames at the same time by using a plurality of wireless channels. The configuration illustrated in the drawings is illustrative, and for example, communication apparatuses that perform wireless LAN communication may be present in a wider area. These communication apparatuses including the AP 102 and the STA 103 may be the communication apparatuses that perform the wireless LAN communication complying with the IEEE802.11be standard. Alternatively, these communication apparatuses may be legacy apparatuses complying with only IEEE802.11a/b/g/n/ac/ax standards while not complying with the IEEE802.11be standard. Yet alternatively, these communication apparatuses may be communication apparatuses complying with succeeding standards developed after the IEEE802.11be standard. In the following description, the AP 102 and the STA 103 are described as examples.

### (Configurations of AP and STA)

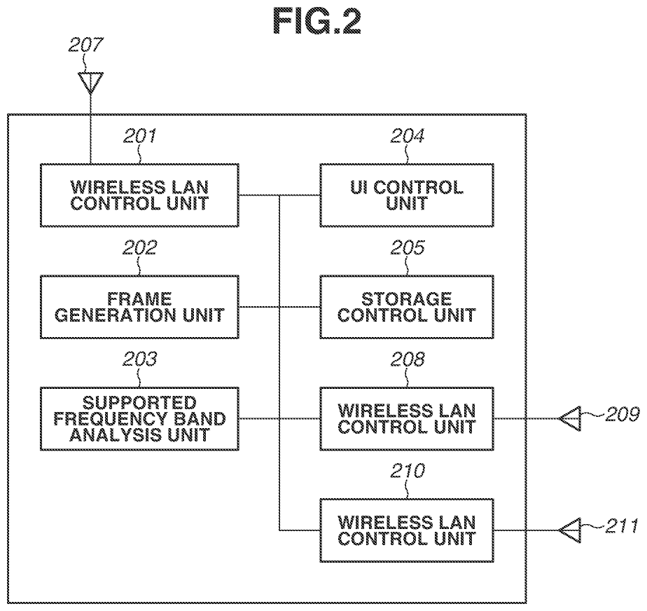

FIG. 2 is a block diagram illustrating a functional configuration of each of the AP 102 and the STA 103. Each of the AP 102 and the STA 103 includes three wireless LAN control units 201, 208, and 210. The number of wireless LAN control units is not limited to three as long as a plurality of wireless LAN control units are provided. Each of the AP 102 and the STA 103 further includes a frame generation unit 202, a supported frequency band analysis unit 203, a user interface (UI) control unit 204, a storage control unit 205, and wireless antennae 207, 209, and 211.

Each of the wireless LAN control units 201, 208, and 210 includes an antenna and a circuit for transmission and reception of a wireless signal with other communication apparatuses, and programs controlling the antenna and the circuit. The wireless LAN control unit 201 performs communication control of the wireless LAN based on a frame generated by the frame generation unit 202, in accordance with the IEEE802.11 standard series. The frame generation unit 202 generates a frame to be transmitted from the wireless LAN control unit 201 based on a result of analysis made by the supported frequency band analysis unit 203. Depending on a case, the frame generation unit 202 also generates a frame having contents independent of the supported frequency band analysis unit 203.

The supported frequency band analysis unit 203 analyzes a frequency band supported by the AP 102 or the STA 103. For example, in a case where the wireless LAN control unit 201 supports a 2.4 GHz band, the wireless LAN control unit 208 supports a 5 GHz band, and the wireless LAN control unit 210 supports a 6 GHz band, the supported frequency band analysis unit 203 analyzes the supported frequencies, and inputs a result of the analysis to the frame generation unit 202. The frequency band supported by each of the wireless LAN control units is determined depending on performance of a communication unit 306 and wireless antennae 307, 308, and 309 described below. However, in addition to the performance of the communication unit and the wireless antennae, limitation may be set depending on setting stored in the storage control unit 205, or limitation may be changed by user setting from the UI control unit 204.

The UI control unit 204 includes hardware and programs controlling the hardware. The hardware relates to a user interface, such as a touch panel and buttons, for receiving operation to the AP 102 by a user using the AP 102. The UI control unit 204 includes a function to present information to the user by, for example, displaying an image or outputting sound. The storage control unit 205 controls reading and writing of data from/to a storage unit, such as a read only memory (ROM) and a random access memory (RAM), storing programs executed by the AP 102 and data.

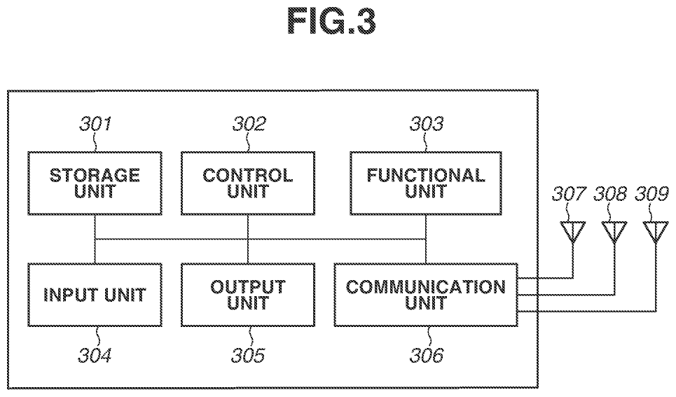

FIG. 3 illustrates a hardware configuration of each of the AP 102 and the STA 103 according to the present exemplary embodiment. As an example of the hardware configuration, each of the AP 102 and the STA 103 includes a storage unit 301, a control unit 302, a functional unit 303, an input unit 304, an output unit 305, the communication unit 306, and the wireless antennae 307, 308, and 309.

The storage unit 301 includes one or more memories, for example, one or both of a ROM and a RAM, and stores programs for various operations describe below, and various types of information such as a communication parameter for wireless communication. As the storage unit 301, a storage medium, such as a flexible disk, a hard disk, an optical disc, a magnetooptical disc, a compact disc-read only memory (CD-ROM), a compact disc-recordable (CD-R), a magnetic tape, a nonvolatile memory card, and a digital versatile disk (DVD) may be used, in addition to the memory, such as the ROM and the RAM.

The control unit 302 includes, for example, one or more processors, such as a central processing unit (CPU) and a micro processing unit (MPU), an application specific integrated circuit (ASIC), a digital signal processor (DSP), and a field programmable gate array (FPGA). The control unit 302 controls the entire apparatus by executing the programs stored in the storage unit 301. The control unit 302 may control the apparatus in cooperation with the programs stored in the storage unit 301 and an operating system (OS). The control unit 302 controls the functional unit 303 to perform predetermined processing, such as image capturing, printing, and projection. The functional unit 303 is hardware for the AP 102 or the STA 103 to perform predetermined processing. For example, in a case where the AP 102 or the STA 103 is a camera, the functional unit 303 is an image capturing unit and performs image capturing processing. For another example, in a case where the AP 102 or the STA 103 is a printer, the functional unit 303 is a printing unit and performs printing processing. For yet another example, in a case where the AP 102 or the STA 103 is a projector, the functional unit 303 is a projection unit and performs projection processing. Data processed by the functional unit 303 may be data stored in the storage unit 301, or data communicated with another communication apparatus through the communication unit 306 described below.

The input unit 304 receives various operations from the user. The output unit 305 performs various outputs to the user. The outputs by the output unit 305 include at least one of display on a screen, sound output by a speaker, vibration output, and the like. Both of the input unit 304 and the output unit 305 may be implemented by one module such as a touch panel. Each of the input unit 304 and the output unit 305 may be integrated with the AP 102 or the STA 103, or may be separated from the AP 102 or the STA 103.

The communication unit 306 includes a wireless LAN chip, and controls wireless communication complying with the IEEE802.11 standard series and internet protocol (IP) communication. In the present exemplary embodiment, the communication unit 306 can perform processing complying with at least the IEEE 802.11be standard. The communication unit 306 is a processing apparatus that generates a physical layer (PHY) protocol data unit (PPDU) complying with the IEEE802.11 standard series. The communication unit 306 transmits and receives a wireless signal for wireless communication by controlling the wireless antennae 307, 308, and 309. Each of the AP 102 and the STA 103 communicates content, such as image data, document data, and video data, with other communication apparatuses through the communication unit 306. In the example of FIG. 3, only one communication unit 306 is provided; however, other communication units corresponding to the respective wireless antennae (three communication units in example of FIG. 3) may be provided.

Each of the wireless antennae 307, 308, and 309 is capable of transmitting and receiving a wireless signal in any of the frequency bands of the 2.4 GHz band, the 5 GHz band, and the 6 GHz band. Each of the wireless antennae 307, 308, and 309 may physically include two or more antennae in order to implement multi-input and multi-output (MIMO) transmission and reception. The AP 102 may be an AP-dedicated communication apparatus such as a wireless LAN router, or a communication apparatus including an AP function, such as a smartphone, a camera, and a printer as long as the AP 102 is a communication apparatus including the configurations illustrated in FIG. 2 and FIG. 3.

### (Flow of Processing)

Subsequently, some exemplary embodiments about a flow of processing performed by the above-described AP and STA, and a sequence by a wireless communication system will be described.

### First Exemplary Embodiment

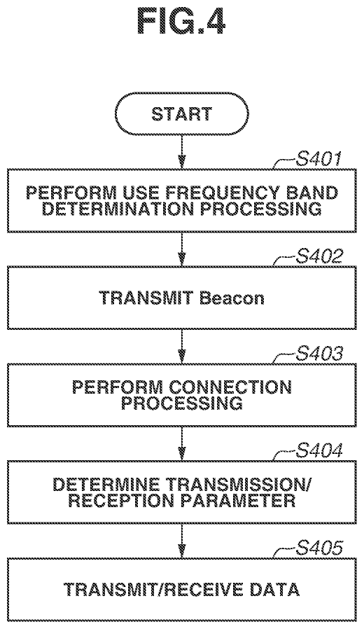

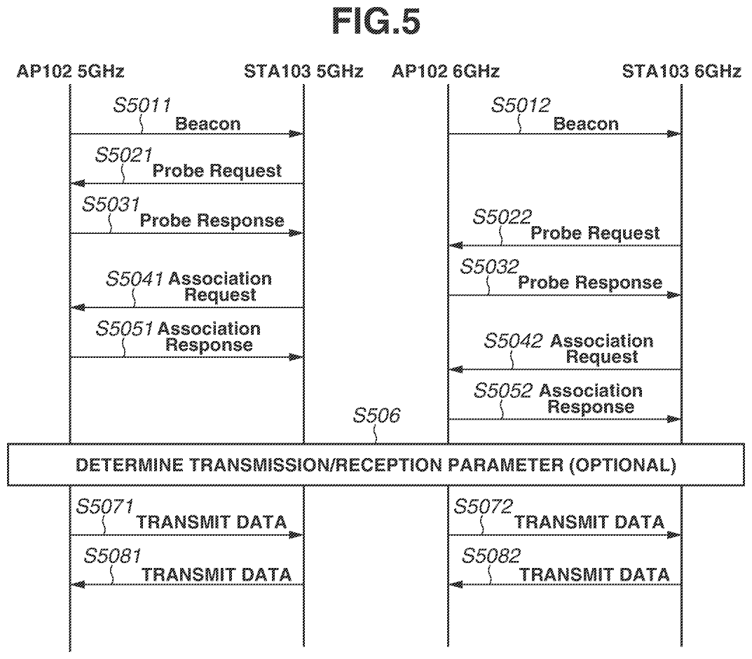

FIG. 4 and FIG. 5 illustrate processing from the operation in which the AP 102 is connected to the STA 103 and to the operation in which data is transmitted. FIG. 4 is a flowchart of processing performed by the AP 102, and the operations in steps are processed by the control unit 302 of the AP 102 executing programs stored in the storage unit 301. FIG. 5 is a sequence diagram illustrating signals that are transmitted and received between the AP 102 and the STA 103 in each of the 5 GHz band and the 6 GHz band, and transmission and reception timings. In the present exemplary embodiment, each of the AP 102 and the STA 103 includes wireless LAN control units that can perform communication in the 2.4 GHz band, the 5 GHz band, and the 6 GHz band.

Initially, in step S401, the AP 102 determines which frequency bands are to be used by the AP 102. More specifically, the AP 102 determines frequency bands to be used (hereinafter, also referred to as use frequency bands) by the AP 102 from the three frequency bands of the 2.4 GHz band, the 5 GHz band, and the 6 GHz band usable by the AP 102. The use frequency bands may be determined based on a congestion degree of a surrounding wireless environment; however, the determination method is not limited thereto. As a method of checking the congestion degree, there is a method in which Probe Request is transmitted in the frequency bands to be checked, and the number of Probe Requests for each of which a Probe Response has been received as a response is counted. Alternatively, a method in which the number of Beacons received in a predetermined period is counted, a method in which the number of times of carrier sense operations in a predetermined period is counted, a method by which information is exchanged with another AP, or the like is usable; however, the method is not limited thereto. In the present exemplary embodiment, all of the 2.4 GHz band, the 5 GHz band, and the 6 GHz band are determined to be the use frequency bands.

After determining the use frequency bands, the AP 102 sets, as use frequency band information, a value of Band ID in Multi-band element of a Beacon frame based on the determined use frequency bands. In steps S402, S5011, and S5012, the AP 102 transmits the Beacon frame in at least one of the use frequency bands at Beacon Interval. The Beacon Interval is typically 100 milliseconds; however, the Beacon Interval is not limited thereto. The value of the Band ID set based on the use frequency bands may include only information other than the frequency bands in which Beacon is transmitted. For example, the Beacon transmitted in the 2.4 GHz band includes information about the 5 GHz band and the 6 GHz band as the use frequency band information. The Beacon transmitted in the 5 GHz band includes information about the 2.4 GHz band and the 6 GHz band as the use frequency band information. Further, the Beacon transmitted in the 6 GHz band may include information about the 2.4 GHz band and the 5 GHz band as the use frequency band information. This is because it is obvious that the frequency band used for transmission of Beacon is a use frequency band, and it is unnecessary to include the information about the frequency band used for transmission of Beacon in the value of Band ID anew. This makes it possible to reduce a communication data amount.

The use frequency band information may be provided not only to the Beacon frame but also to Probe Response, Association Response, or Reassociation Response transmitted by the AP 102. The STA 103 itself may notify the AP 102 of the use frequency band thereof by adding information about the use frequency band thereof to Probe Request, Association Request, or Reassociation Request. In other words, the use frequency band information can be transmitted by being imparted to a management frame defined by the IEEE802.11 standard.

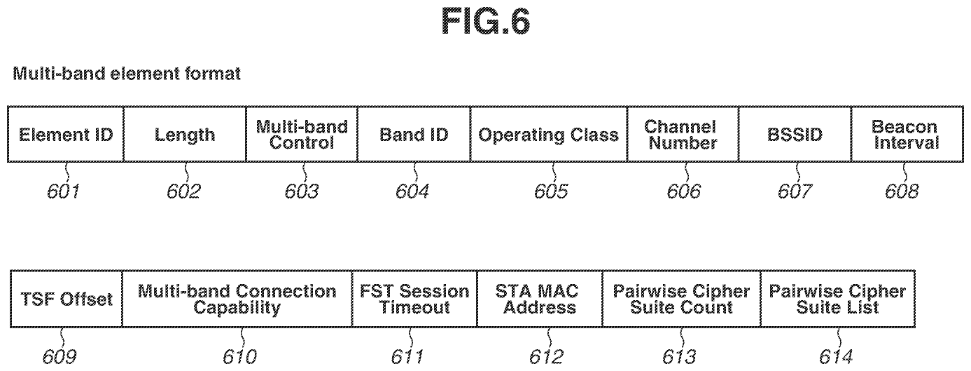

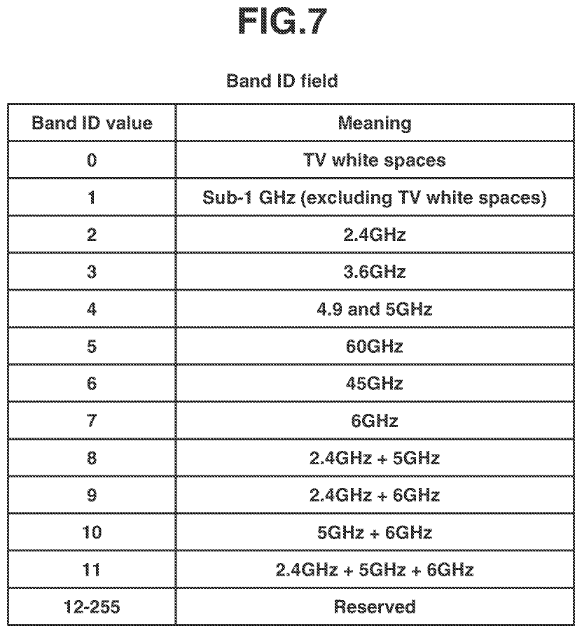

The use frequency band information can be represented by the Multi-band element format illustrated in FIG. 6. In the present exemplary embodiment, a Band ID value indicating a combination of any two of the frequency bands of the 2.4 GHz band, the 5 GHz band, and the 6 GHz band is added to a Band ID field 604. More specifically, a Band ID value=8 illustrated in FIG. 7 is newly defined as a numerical value indicating a combination of the 2.4 GHz band and the 5 GHz band. A Band ID value=9 is newly defined as a numerical value indicating a combination of the 2.4 GHz band and the 6 GHz band, and a Band ID value=10 is newly defined as a numerical value indicating a combination of the 5 GHz band and the 6 GHz band. A Band ID value=11 is newly defined as a numerical value indicating a combination of the 2.4 GHz band, the 5 GHz band, and the 6 GHz band. The Band ID values may be any values that can define the correspondence, and are not limited to the values illustrated in FIG. 7. The AP 102 may further store information about a channel operable with a combination of an Operating Class field 605 and a Channel Number field 606.

In step S403, the AP 102 establishes a connection with the STA 103. At this time, in steps S5021 and S5022, the STA 103 transmits a Probe Request by using one of the frequency bands usable by the STA 103, and starts scan operation. The STA 103 can detect the information about the use frequency band of the AP 102 by using the Band ID value included in the Probe Response obtained as a response in step S5031. Thereafter, in step S5022, the STA 103 may transmit a Probe Request in each of the supported frequency bands for confirmation. In response to the AP 102 receiving the Probe Request transmitted in the respective use frequency bands of the AP 102, the AP 102 returns a Probe Response. Thereafter, transmission and reception of Authentication Request and Authentication Response (not illustrated) are performed. In steps S5041 and S5042, the AP 102 receives an Association request, and in steps S5051 and S5052, the AP 102 transmits an Association Response, thus establishing a connection. To establish a secure connection using encryption between the AP 102 and the STA 103, communication processing (not illustrated), such as Wi-Fi Protected access (WPA), WPA2, and WPA3, may be performed thereafter. The STA 103 may establish a connection in two or more of the usable frequency bands. For example, in a case where the three frequency bands are usable, the STA 103 may establish the connections by using two or all of the frequency bands.

After the connection is established, the AP 102 determines a transmission/reception parameter in step S404. The transmission/reception parameter is information for determining, in a case where the connections are established in the plurality of frequency bands, how to distribute transmission and reception data to the connection in each of the frequency bands. For example, a distribution amount of data can be determined in accordance with a maximum throughput usable in each of the frequency bands, or the distribution amount can be determined by actually transmitting a test packet and calculating a current throughput. Different streams may be independently transmitted and received through the connection in each of the frequency bands without the transmission/reception parameter determined. Thereafter, in steps S405, S5071, S5072, S5081, and S5082, the AP 102 transmits and receives data based on the transmission/reception parameter determined in step S404.

As described above, according to the present exemplary embodiment, the STA 103 can determine the use frequency bands for the AP 102, appropriately establish connections in the plurality of frequency bands based on the use frequency bands for the AP 102, and transmit and receive data.

### Second Exemplary Embodiment

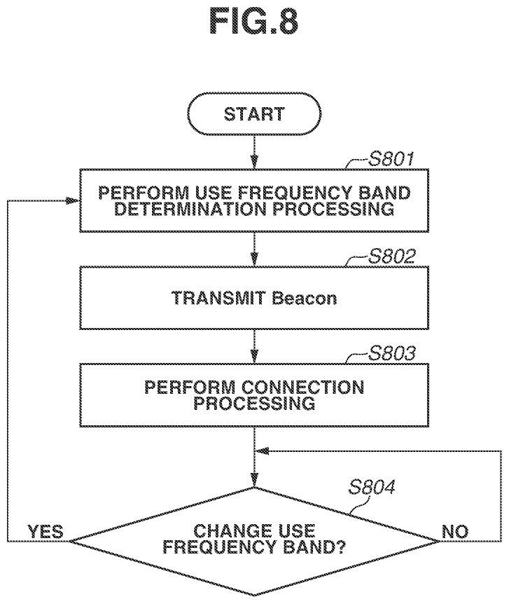

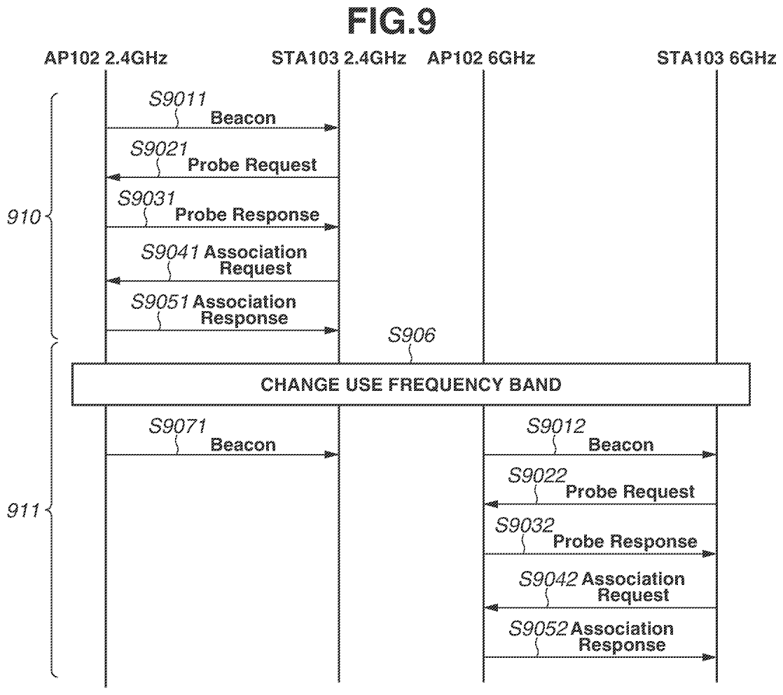

FIG. 8 and FIG. 9 illustrate processing when the AP 102 is connected to the STA 103 and dynamically changes the use frequency bands for the AP 102, according to a second exemplary embodiment. FIG. 8 is a flowchart of processing performed by the AP 102, and the operations in each step are processed by the control unit 302 of the AP 102 executing programs stored in the storage unit 301. FIG. 9 is a sequence diagram illustrating signals transmitted and received between the AP 102 and the STA 103 in each of the 2.4 GHz band and the 6 GHz band, and transmission and reception timings. In the present exemplary embodiment, each of the AP 102 and the STA 103 includes wireless LAN control units that can perform communication in the 2.4 GHz band, the 5 GHz band, and the 6 GHz band.

Initially, in step S801, the AP 102 determines use frequency bands for the AP 102 itself. More specifically, the AP 102 determines the frequency bands to be used from the three frequency bands of the 2.4 GHz band, the 5 GHz band, and the 6 GHz band, which are usable by the AP 102. The use frequency bands may be determined based on, for example, a congestion degree of a surrounding wireless environment; however, the determination method is not limited thereto. As a method of checking the congestion degree, there is a method in which Probe Requests are transmitted in the frequency band to be checked, and the number of Probe Requests for each of which the Probe Response has received as a response is counted. Alternatively, a method in which the number of Beacons received in a predetermined period is counted, a method in which the number of times of carrier sense operations in a predetermined period is counted, a method in which information is exchanged with other APs, or the like is usable; however, the method is not limited thereto. In the present exemplary embodiment, the 6 GHz band is congested during a period 910 in FIG. 9, and communication is performed by using the two frequency bands of the 2.4 GHz band and the 5 GHz band. In a period 911, the congestion in the 6 GHz band is released.

Initially, the AP 102 detects congestion of the surrounding wireless environment during the period 910, and determines the 2.4 GHz band and the 5 GHz band as the use frequency bands.

After determining the frequency bands to be used, the AP 102 sets, as the use frequency band information, a value of the Band ID in Multi-band element of a Beacon frame based on the determined use frequency bands. In steps S802 and S9011, the AP 102 transmits the Beacon frame in at least one of the use frequency bands at Beacon Interval. Beacon Interval is typically 100 milliseconds; however, Beacon Interval is not limited thereto. Operations in steps S801 to S803 and operations in steps S9011 to S9051 are respectively similar to the operations in steps S401 to 403 and the operations in steps S5011 to S5051 according to the first exemplary embodiment.

In step S804 (S906), the AP 102 determines whether to change the use frequency bands. In the present exemplary embodiment, the AP 102 periodically detects the above-described congestion, and determines whether to change the use frequency bands, based on change in the congestion. More specifically, in a case where a level indicating the congestion is lower than a prescribed threshold, the use frequency bands are changed; however, the method is not limited thereto.

In a case where it is determined that the use frequency bands are not to be changed (NO in step S804), the AP 102 periodically determines whether to change the use frequency bands again. In a case where it is determined that the use frequency band to be changed (YES in step S804), the processing returns to the use frequency band determination processing in step S801, and the AP 102 determines the use frequency bands again. In a case where there is a frequency band determined to be newly used and/or the frequency band the use of which is determined to stop, the AP 102 updates the use frequency band information transmitted in step S802.

For example, it is assumed that, in step S906, the AP 102 determines the 6 GHz band to be the frequency band to be newly used because the congestion in the 6 GHz band is released in the period 911. At this time, information indicating that the three frequency bands of the 2.4 GHz band, the 5 GHz band, and the 6 GHz band are usable is added to the use frequency band information for the Beacon frame transmitted in step S9071. Further, in step S9012, the AP 102 starts transmission of the Beacon frame also in the 6 GHz band at Beacon Interval. In step S9071, the STA 103 receives the Beacon frame in the 2.4 GHz band and the 5 GHz band. The STA 103 receives the use frequency band information, thus detecting that the AP 102 is usable in the 6 GHz band. Thereafter, in steps S9012 to S9052, the AP 102 and the STA 103 perform communication connection processing in the 6 GHz band. The communication connection processing is similar to the processing in steps S5012 to S5052. Thus, the detailed description of the connection processing is omitted.

As described above, dynamically changing the use frequency band information based on the state of each of the frequency bands makes it possible to flexibly perform communication using the appropriate frequency bands.

### Third Exemplary Embodiment

In a third exemplary embodiment, a case of using a format different from the Multi-band element format used in each of the first and second exemplary embodiments will be described. Processing regarding determination and notification of the use frequency bands between the AP 102 and the STA 103 is similar to those described in each of the first and second exemplary embodiments. Thus, in the present exemplary embodiment, the Multi-band element format will be mainly described.

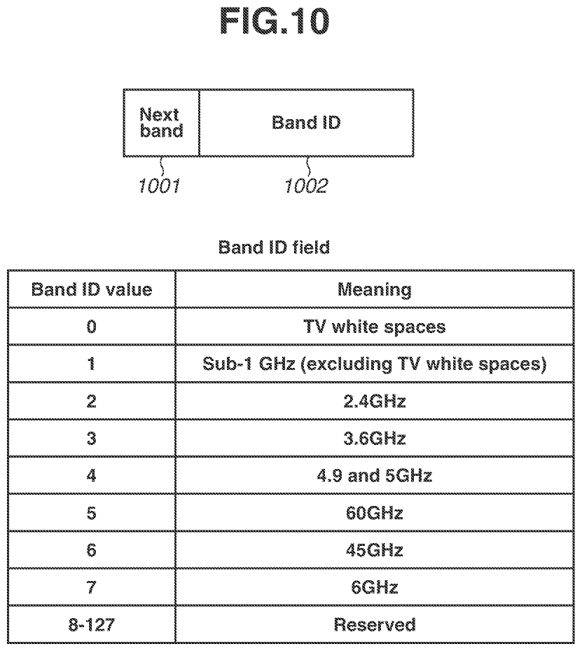

In the present exemplary embodiment, a format in which the 8-bit Band ID field 604 in FIG. 6 is replaced with a 1-bit Next band field 1001 and a 7-bit Band ID field 1002 illustrated in FIG. 10 is used. Information about one frequency band is stored in the Band ID field 1002. The Next band field 1001 and the Band ID field 1012 form a set.

The value of the Next band field being one indicates that the Band ID field is followed by a set of Next band field and Band ID field. The value of the Next band field being zero indicates that the Band ID field is not followed by the set of Next band field and Band ID field, and is followed by an Operating Class field.

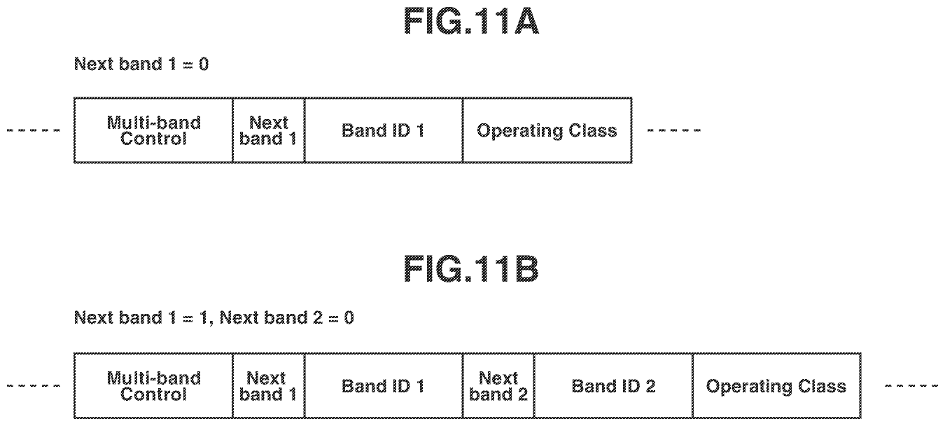

FIG. 11A illustrates a case where the value of the Next band field is 0. In this case, the Band ID field and the Operating Class field are arranged in this order. The use frequency band is indicated by the Band ID field.

FIG. 11B illustrates a case where the value of the Next band field is 1 (illustrated as Next band field 1 in FIG. 11B). In this case, the Band ID field 1 indicates a first use frequency band. A Next band field 2 indicates presence/absence of a third use frequency band by one bit. In FIG. 11B, the value of the Next band field 2 is 0, and the number of use frequency bands is two. A Band ID field 2 indicates a second use frequency band. The Band ID field 2 is followed by the Operating Class field.

In a case where the three frequency bands of the 2.4 GHz band, the 5 GHz band, and the 6 GHz band are usable, Multi-band element is configured to include three sets of Next band field and Band ID field. In other words, Multi-band element is configured such that the value of each of the first and second Next band fields is 1, and the value of the third Next band field is 0. The Band ID fields are configured such that, for example, the first Band ID field corresponds to the 2.4 GHz band, the second Band ID field corresponds to the 5 GHz band, and the third Band ID field corresponds to the 6 GHz band.

The STA 103 can recognize the plurality of frequency bands supported by the AP 102 in the above-described manner, appropriately establish connections in the plurality of frequency bands based on the supported frequency bands, and transmit and receive data.

### OTHER EXEMPLARY EMBODIMENTS

The present invention can be realized by supplying programs realizing one or more functions of the above-described exemplary embodiments to a system or an apparatus through a network or a storage medium, and causing one or more processors of a computer in the system or the apparatus to read out and execute the programs. The present invention can be realized by a circuit (e.g., ASIC) implementing one or more functions.

The present invention is not limited to the above-described exemplary embodiments, and can be variously modified and alternated without departing from the sprit and the scope of the present invention. Accordingly, to apprise the public of the scope of the present invention, the following claims are made.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The exemplary embodiments of the present invention enable notification that an apparatus supports wireless LAN communication using a plurality of frequency bands.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus, comprising:
a generation unit configured to generate a management frame complying with an Institute of Electrical and Electronics Engineers (IEEE) 802.11 standard; and
a transmission unit configured to transmit the management frame generated by the generation unit,
wherein the management frame includes a Multi-band element, and any of a set of 2.4 GHz band and 5 GHz band, a set of 5 GHz band and 6 GHz band, a set of 2.4 GHz band and 6 GHz band, and a set of 2.4 GHz band, 5 GHz band, and 6 GHz band is set as information indicating frequency bands to be used by the communication apparatus, to a Band ID value included in the Multi-band element.

2. The communication apparatus according to claim 1, wherein, in the management frame, information indicating any of the set of 2.4 GHz band and 5 GHz band, the set of 5 GHz band and 6 GHz band, the set of 2.4 GHz band and 6 GHz band, and the set of 2.4 GHz band, 5 GHz band, and 6 GHz band is indicated, as the information indicating the frequency bands to be used by the communication apparatus, by a Band ID value set to a single Band ID field.

3. The communication apparatus according to claim 1, wherein, in the management frame, information indicating any of the set of 2.4 GHz band and 5 GHz band, the set of 5 GHz band and 6 GHz band, the set of 2.4 GHz band and 6 GHz band, and the set of 2.4 GHz band, 5 GHz band, and 6 GHz band is indicated, as the information indicating the frequency bands to be used by the communication apparatus, by Band ID value set to each of a plurality of Band ID fields.

4. The communication apparatus according to claim 1, wherein the management frame is any of a Beacon, a Probe Request, a Probe Response, an Association Request, an Association Response, a Reassociation Request, and a Reassociation Response.

5. The communication apparatus according to claim 1, further comprising a determination unit configured to determine frequency bands to be used,
wherein the Band ID value included in the management frame is changed based on the determination.

6. The communication apparatus according to claim 1, wherein the transmission unit transmits the management frame in any of a plurality of the frequency bands to be used by the communication apparatus.

7. The communication apparatus according to claim 6, wherein information indicating a frequency band excluding the frequency band used for transmission of the management frame, among the frequency bands to be used by the communication apparatus, is set to the Band ID value.

8. A processing apparatus, comprising:
a generation unit configured to generate a management frame complying with an Institute of Electrical and Electronics Engineers (IEEE) 802.11 standard,
wherein the management frame includes a Multi-band element, and any of a set of 2.4 GHz band and 5 GHz band, a set of 5 GHz band and 6 GHz band, a set of 2.4 GHz band and 6 GHz band, and a set of 2.4 GHz band, 5 GHz band, and 6 GHz band is set as information indicating frequency bands to be used by the communication apparatus, to a Band ID value included in the Multi-band element.

9. A communication method, comprising:
generating a management frame complying with an Institute of Electrical and Electronics Engineers (IEEE) 802.11 standard; and
transmitting the generated management frame,
wherein the management frame includes a Multi-band element, and any of a set of 2.4 GHz band and 5 GHz band, a set of 5 GHz band and 6 GHz band, a set of 2.4 GHz band and 6 GHz band, and a set of 2.4 GHz band, 5 GHz band, and 6 GHz band is set as information indicating frequency bands to be used by the communication apparatus, to a Band ID value included in the Multi-band element.

10. A non-transitory computer-readable storage medium storing a program for causing a computer to execute a communication method, wherein the communication method comprising:
generating a management frame complying with an Institute of Electrical and Electronics Engineers (IEEE) 802.11 standard; and
transmitting the generated management frame,
wherein the management frame includes a Multi-band element, and any of a set of 2.4 GHz band and 5 GHz band, a set of 5 GHz band and 6 GHz band, a set of 2.4 GHz band and 6 GHz band, and a set of 2.4 GHz band, 5 GHz band, and 6 GHz band is set as information indicating frequency bands to be used by the communication apparatus, to a Band ID value included in the Multi-band element.
